(19) United States
(12) Patent Application Publication
(10) Pub. No.: US 2025/0220643 A1
(43) Pub. Date: Jul. 3, 2025

(54) METHOD FOR CONTROLLING A WIRELESS MULTI-CHANNEL AUDIO SYSTEM AND WIRELESS MULTI-CHANNEL AUDIO SYSTEM

(71) Applicant: Sennheiser electronic SE & Co. KG, Wedemark (DE)

(72) Inventors: Steffen Matthias, Hannover (DE); Sebastian Georgi, Langenhagen (DE); Jan Watermann, Hannover (DE)

(73) Assignee: Sennheiser electronic SE & Co. KG, Wedemark (DE)

(21) Appl. No.: 18/976,497

(22) Filed: Dec. 11, 2024

(30) Foreign Application Priority Data
Dec. 27, 2023 (DE) 102023136696.3

(51) Int. Cl. H04W 72/0446; H04J 3/16; H04S 7/00

(52) U.S. Cl. CPC H04W 72/0446; H04J 3/1694; H04S 7/00; H04S 2400/01

(57) ABSTRACT

A method for controlling a wireless multi-channel audio system (100) is provided, wherein the system (100) has at least two mobile devices (300), each for transmitting and/or receiving audio data in the form of at least one audio stream, and at least one base station (400), wherein the mobile devices (300) and the base station (400) exchange audio data wirelessly in a Time Division Multiplex Access TDMA method, wherein this wireless transmission takes place on the basis of repeating frames (SF), wherein each frame (SF) has a number (A) of time slots (SL), wherein each mobile device (300) transmits or receives audio data of an audio stream in at least one time slot (SL) at least once per frame (SF), wherein each audio stream transmitted in the frame (SF) occupies a proportion (T) of the time slots (SL) of the frame (SF), wherein the base station (400) transmits control data (201) to the mobile devices (300) for controlling the wireless transmission. The method comprises the following steps: In response to a user input to add further audio data of at least one further audio stream: searching for at least one time slot (SL) in the frame (SF) which is not occupied by an audio stream with a larger or equal proportion (T) of the time slots (SL), placing a new audio stream in the at least one time slot (SL) which has been found, recording all the already existing audio streams displaced thereby, searching for at least one further time slot (SL) in the frame (SF) for a next or a displaced audio stream which is not occupied by an audio stream with a larger or equal proportion (T) of the time slots (SL), placing a new or displaced audio stream in the further time slot (SL) which has been found, and repeating the steps of searching and placing until all the audio streams have been accommodated in the time slots. Each audio stream is distributed substantially isochronously in the time slots of the frames.

The present invention relates to a method for controlling a wireless multi-channel audio system and a wireless multi-channel audio system.

Wireless multi-channel audio systems are known from ETSI EN 300422. Such an audio system is a wireless audio system in which several channels are used for audio transmission. In this case, several wireless transmitters (for example, wireless microphones) and several wireless receivers (for example, in-ear monitoring units) can communicate with a base station at the same time.

In the priority application of this application, the German Patent and Trademark Office has searched the following documents: DE 10 2021 116 893 A1 and DE 10 2009 031 995 A1.

It is an object of the present invention to provide a wireless multi-channel audio system which enables improved transmission of multiple audio streams with reduced latency.

This object is achieved by a method for controlling a wireless multi-channel audio system according to claim 1 and by a wireless multi-channel audio system according to claim 7.

Thus, a method for controlling a wireless multi-channel audio system is provided. The multi-channel audio system has at least two mobile devices for transmitting and/or receiving audio data in the form of at least one audio stream and at least one base station. The mobile devices and the base station exchange audio data in the form of an audio stream in a Time Division Multiplex Access TDMA. This wireless transmission takes place on the basis of repeating frames. Each frame has a number A of time slots. Each mobile device transmits or receives audio data of an audio stream in at least one time slot at least once per frame. Each audio stream transmitted in the frame occupies a proportion of the time slots. The base station transmits control data to the mobile devices for controlling the wireless transmission. In response to a user input to add further audio data of at least one further audio stream, a search is carried out for at least one time slot in the frame which is not occupied by an audio stream with a larger or equal proportion of the time slots. The new audio stream is placed in the time slot or time slots which has/have been found. All the already existing audio streams displaced thereby are recorded. At least one additional time slot in the frame is sought for the next or displaced audio stream, which is not occupied by an audio stream with a larger or equal proportion of the time slots. The new or displaced audio stream is placed in the additional time slot which has been found. These steps are repeated until all the audio streams have been accommodated in the time slots. Each audio stream is substantially distributed isochronously in the time slots of the frame.

According to one aspect of the present invention, those time slots are used for placing a next or a displaced audio stream which displace the fewest previously placed audio streams from the time slots.

According to one aspect of the present invention, the wireless transmission takes place in frequency ranges 470-698 MHz (UHF) or 1350-1525 MHz (1G4), in particular in a frequency band of 270 to 608 MHz, 470 to 510 MHz, 610 to 698 MHz, 1350 to 400 MHz or 1435 to 1525 MHz.

According to a further aspect of the present invention, the mobile devices can be wireless transmitters or wireless receivers. The wireless transmitters can be configured as wireless microphones and the wireless receivers can be configured as in-ear monitoring units.

According to a further aspect of the present invention, by means of the control data the base station transmits information to the mobile devices for re-allocating or redistributing the occupancy of the time slots in the frame. The mobile devices then transmit and receive based on the control data in the time slots assigned to them.

According to one aspect of the present invention, the control data comprises information for each mobile device at the time of the change and for the new starting time slot.

The invention also relates to a wireless multi-channel audio system with at least two mobile devices for transmitting and/or receiving audio data in the form of at least one audio stream and at least one base station. The mobile devices and the base stations exchange data wirelessly using a TDMA method. This wireless transmission is based on repeating frames, each frame having a number A of time slots. Each mobile device transmits audio data of an audio stream in at least one time slot at least once per frame. Each audio stream transmitted in the frame has a proportion of the time slots of the frame. The base station transmits control data to the mobile devices for controlling the wireless transmission. In response to a user input to add further audio data of at least one audio stream, a time slot is sought in the frame that is not occupied by an audio stream with a larger or equal proportion of the time slots. The new audio stream is placed in the time slot which has been found. All the already existing audio streams displaced by this are recorded. A search is then carried out for at least one time slot in the frame for a next or displaced audio stream that is not occupied by an audio stream with a larger or equal proportion of the time slots. The new or displaced audio stream is placed in the additional time slot or time slots which has/have been found. Each audio stream is distributed isochronously in the time slots.

A wireless multi-channel audio system according to ETSI EN 300422 is provided. The audio system has a plurality of mobile devices, which can be configured as wireless transmitters, wireless receivers or as wireless transmitter/receivers. The multi-channel audio system can, for example, comprise at least one mobile audio transmitter, at least one mobile audio data receiver and a wireless base station, which receives audio data in the form of an audio stream from the audio data transmitters and transmits audio data in the form of an audio stream to the mobile audio data receiver in a time division multiplex access (TDMA) method. If several audio data transmitters are provided in the system, the audio streams of these audio data transmitters can then be transmitted in time slots in a frame according to the TDMA method.

According to one aspect, a re-allocation or redistribution method is provided in which all the audio streams to be transmitted are accommodated at least once in the frame and are distributed isochronously (i.e., at uniform time intervals) in the frame.

The mobile devices can be configured as wireless microphones, e.g. handheld microphones, wireless stereo microphones or wireless instrument microphones, as wireless receivers (e.g. in-ear monitoring units) or as wireless transmitters/receivers (e.g. in-ear monitoring units with a microphone connection).

Further embodiments of the invention are the subject of the dependent claims.

Advantages and exemplary embodiments of the invention are explained in more detail below with reference to the drawing.

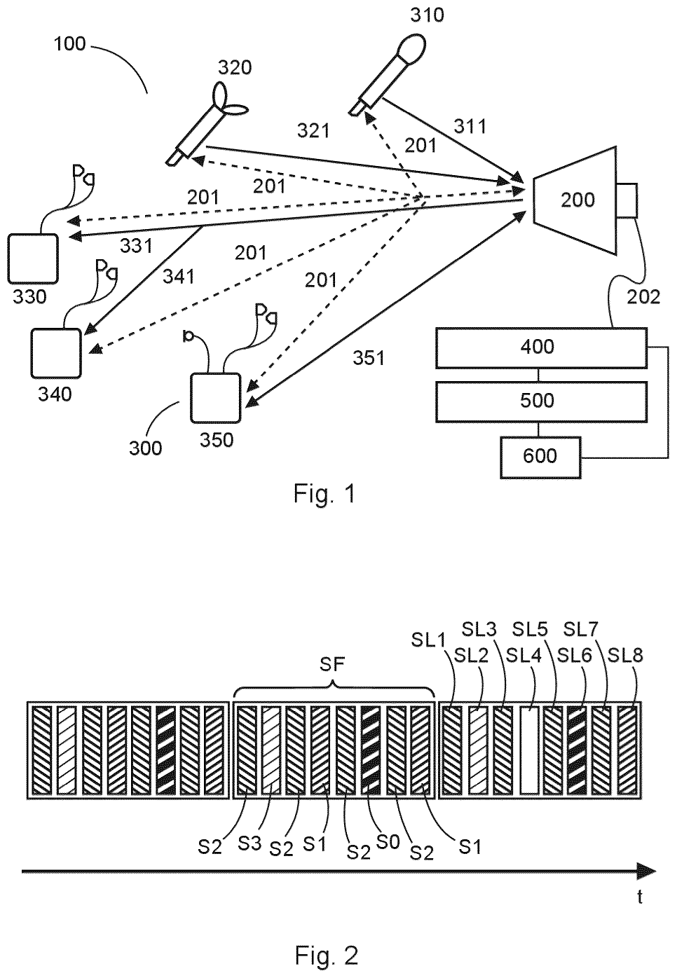

FIG. 1 shows a schematic representation of a wireless multi-channel audio system,

FIG. 2 shows a representation of time slots of different wireless transmitters which are received by the wireless receiver,

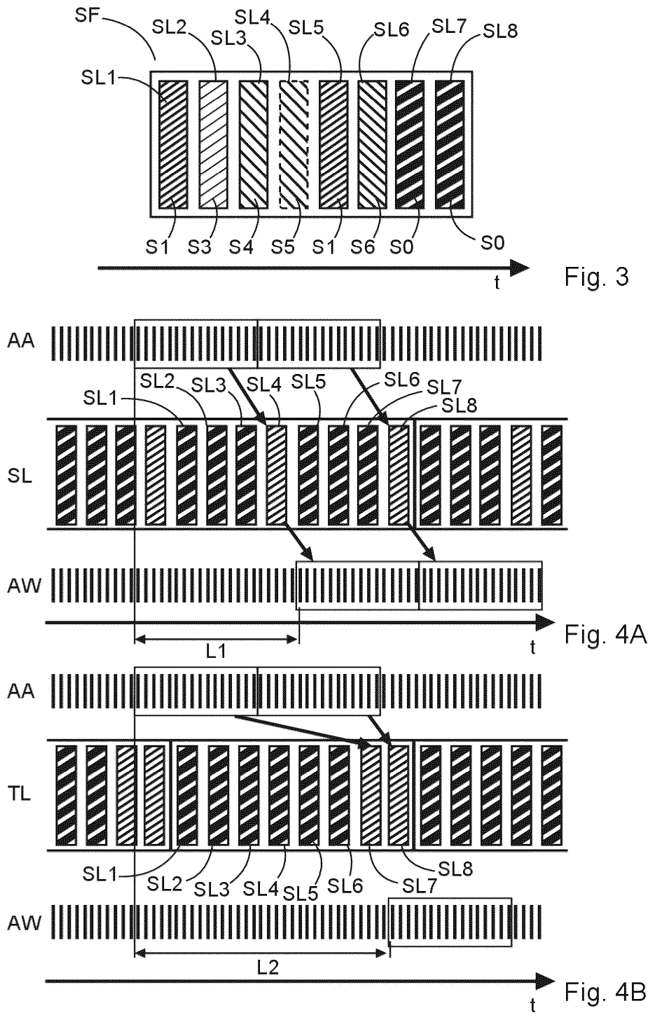

FIG. 3 shows a schematic representation of a frame during the transmission of audio data,

FIGS. 4A and 4B each show a schematic representation of the audio transmission of audio data from different transmitters in a TDMA method,

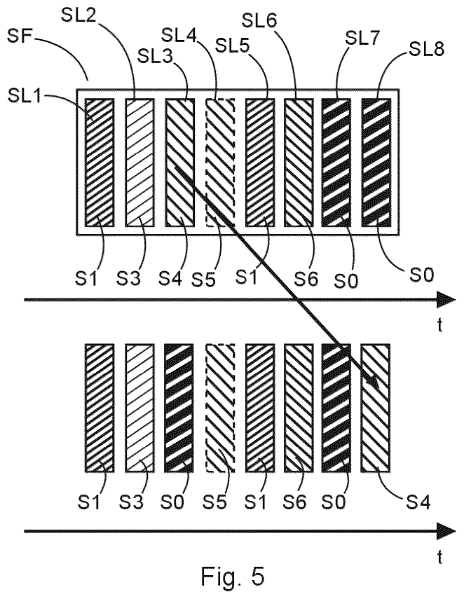

FIG. 5 shows a schematic representation of a regrouping of time slots in a frame according to one example,

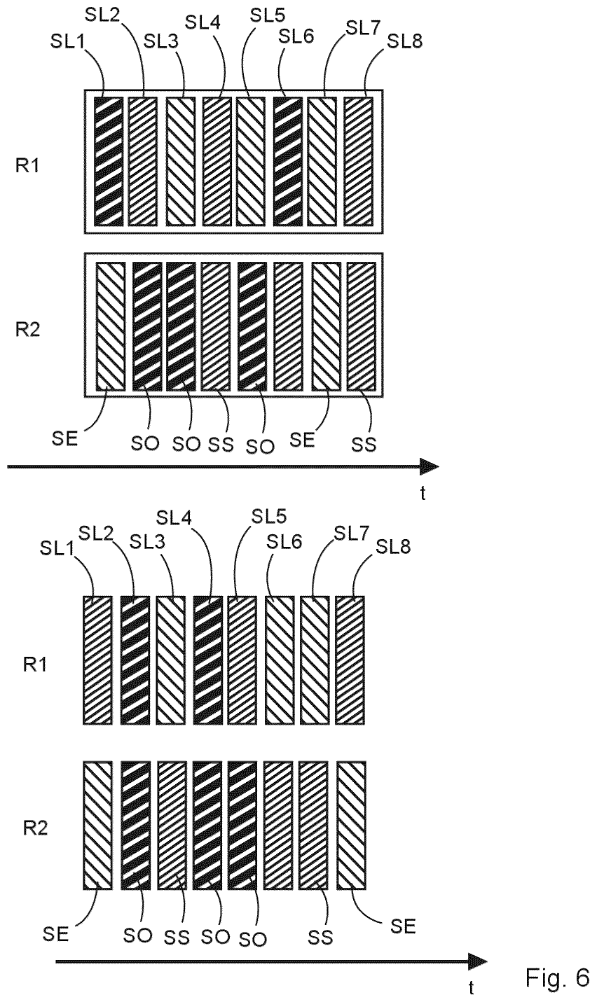

FIG. 6 shows a schematic representation of two audio channels with different sequences of the transmission slots of the respective audio data,

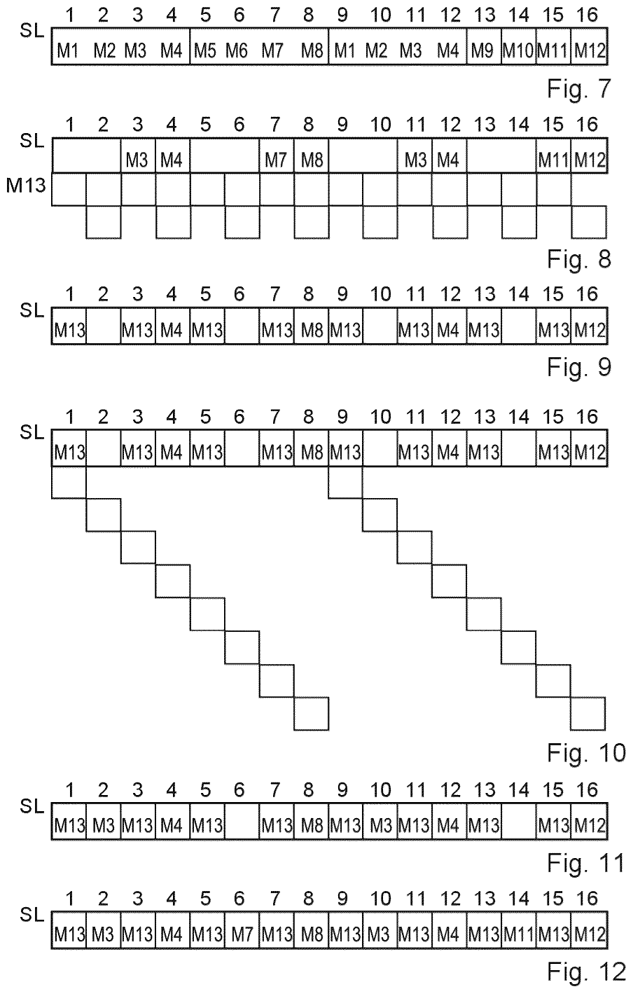

FIGS. 7 to 13 show various steps for re-ordering a frame in the transmission of audio data, and

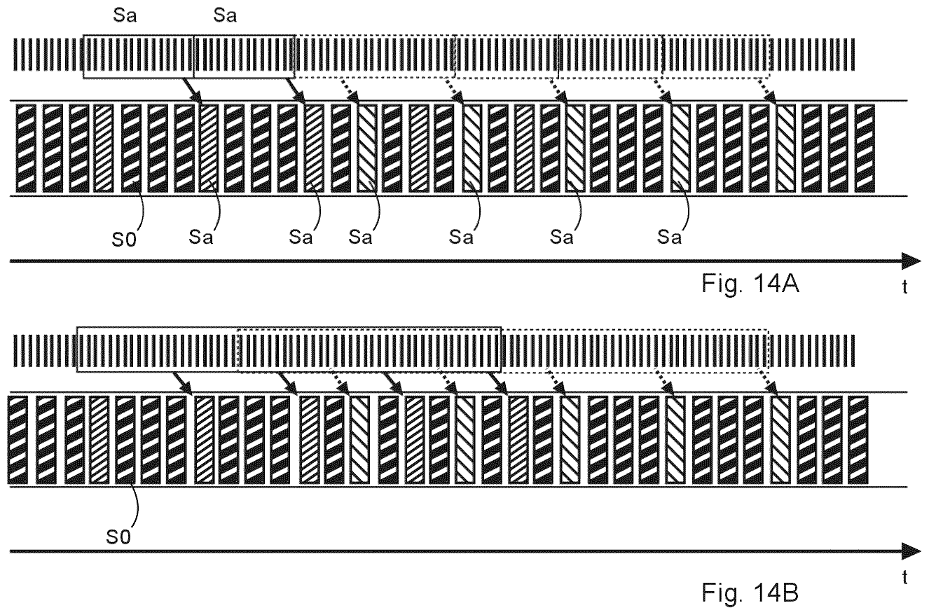

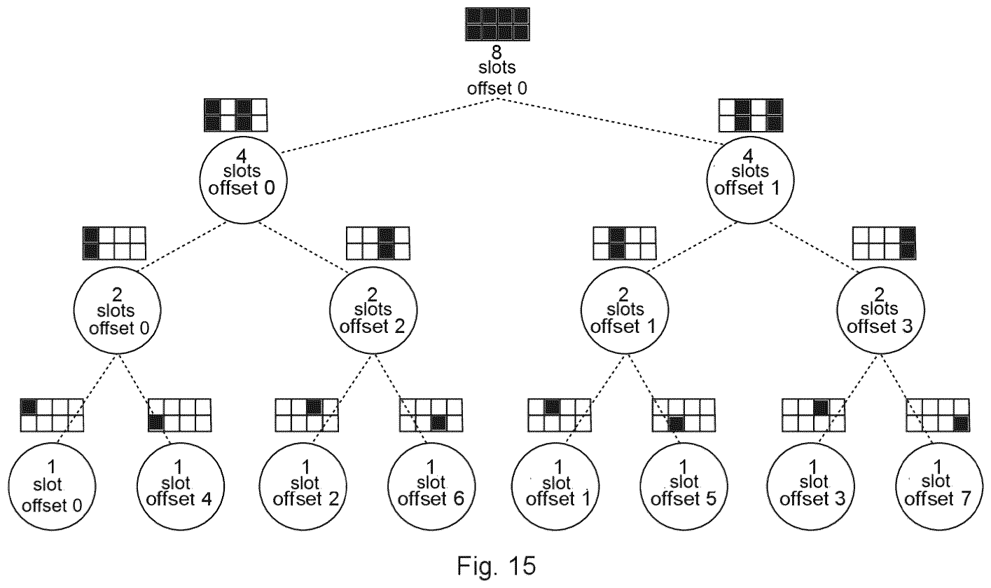

FIG. 14A shows a schematic representation of a transmission of audio and 14B samples in TDMA time slots, and

FIG. 15 shows a schematic representation of a binary tree for determining a redistribution in a frame.

Wireless multi-channel audio systems WMAS are known from ETSI EN 300422. Here, several mobile devices, such as several microphones, several in-ear monitoring units can be used simultaneously with a base station.

If several audio transmitters (for example a handheld microphone or other microphones) transmit audio signals to a base station at the same time and the base station transmits a second audio signal composed of these audio signals to an in-ear monitoring unit or a bodypack or beltpack, then the microphones do not transmit simultaneously, but subscriber access is achieved through a Time Division Multiple Access TDMA system with a repeating frame with a number of time slots per RF channel. For example, 128 time slots per frame can be provided for the transmission of audio streams. In addition, time slots can be provided for control data. Thus, up to 128 mobile devices can communicate with the base station.

The TDMA method ensures multiple access to a wireless audio transmission through a temporal sequence of several subscribers. The minimum latency of the audio data is determined by the largest distance between two consecutive time slots.

FIG. 1 shows a schematic representation of a wireless multi-channel audio system. The wireless multi-channel audio system WMAS 100 is based on ETSI EN 300422 and has a base station 400, at least one antenna 200, and a plurality of mobile devices 300, e.g. at least one handheld microphone (mobile transmitter) 310, optionally at least one multi-channel microphone (mobile transmitter) 320, optionally a first bodypack or beltpack (mobile receiver) 330 with an output for in-ear monitoring, optionally a combined second bodypack or beltpack (mobile receiver) 340 with an input for microphone signals and an output for in-ear monitoring. Thus, the number of mobile transmitters 310, 320 or mobile receivers 330, 340, 350 in the wireless multi-channel audio system 100 can vary.

In the wireless multi-channel audio system 100, the base station 400 is connected to an antenna 200 by means of a cable 202 and provides an RF channel. Optionally, further antennae can be connected to the base station 400, which can provide further RF channels. The antenna 200 can have an RF transmitter (“radiohead”), so that digital signals are transmitted via the cable 202, which are converted into analog RF signals in the radiohead.

A control console 500 connected to the base station 400 can provide a user interface by means of which an operator can enter configuration and control commands for the base station 400. Optionally, the base station 400 can be coupled to a mixer 600. By means of the mixer 600, the audio signals from the respective wireless audio transmitters (e.g. microphones) can be mixed into an overall audio signal.

The wireless multi-channel audio system 100 can, for example, comprise a number of microphones, namely a handheld microphone 310, a multi-channel or stereo microphone 320 and mobile receiving devices 330, 340, 350. The mobile receiving devices 330-350 can have an output for a so-called in-ear monitoring that allows a wearer to receive an audio channel or audio stream. The mobile receiving device 350 can additionally be equipped with a microphone input for a clip-on microphone or lavalier microphone. The user of the mobile receiving device 350 is thus able to simultaneously receive an audio channel or audio stream and transmit another audio channel or audio stream. The microphones 310, 320 and mobile receiving devices 330-350 are collectively referred to below as mobile devices. In other applications, more or fewer mobile devices can be integrated into the wireless multi-channel audio system 100 than shown in FIG. 1.

The microphone 310 can transmit first audio data 311 in the form of an audio stream to the base station 400. The second microphone 320 can transmit second audio data 321 in the form of an audio stream to the base station 400. The mobile device 350 (bodypack or beltpack) can transmit third audio data 351 in the form of an audio stream to the base station 400 (via the antenna 200). The mobile devices 330 and 340 can receive audio data 331, 341 in the form of an audio stream from the base station 400.

The base unit 400 can transmit control data 201 to the respective mobile devices, e.g. transmitter/receiver 310, 320, 330, 340, 350, via the antenna 200. The control data 201 can be used by the mobile devices 310-350 to set parameters of the wireless transmission. By means of the control data 201 the base station 400 can specify transmission parameters for the mobile devices 300, such as a transmission frequency, a time slot in the transmission frame, a transmission power, etc. The base station 400 can thus control the transmission from the mobile devices to the base station 400 and from the base station 400 to the mobile devices 300.

The control data 201 can comprise control and/or status information exchanged between the mobile devices and the base station. In addition to the control information or control data, further data may be exchanged as part of the control data 201.

For example, in a case with 128 TDMA time slots per frame, one time slot can be reserved after 16 time slots. This time slot can be used for control data such as synchronization information and control and status signals.

Optionally, a frame can have 128 TDMA time slots for audio transmission and 8 time slots for control signals, so that a frame has, for example, 136 time slots.

Alternatively, the control data can also be transmitted in those time slots that are not reserved and are therefore free. In this case, no separate time slots are provided for the transmission of the control data, but the control data is then transmitted as and when possible.

The communication from the base station 400 to the mobile devices 340, 350 can be carried out in a multicast and the communication from the mobile devices 310, 320 to the base station 10 can be carried out in a unicast.

The control console 500 may be connected to the base station 400 and may have a user interface (UI) by means of which the user can enter configuration and/or control commands for the base station 400.

The (handheld) microphone 310 can transmit audio data as first audio data 311 in the form of an audio stream wirelessly as a unidirectional radio transmission to the base station 400. This transmission 311 can take place in a unicast. In this case, the audio transmission can take place in the form of mono microphone data.

The microphone 320 can transmit audio signals 321 as an audio stream in the form of a unidirectional radio transmission. In this case, stereo or multi-channel microphone data can be transmitted in a unicast. The first and/or second bodypacks 330, 340 (mobile receiving units) can receive a unidirectional radio transmission (audio data 331, 341) from the base station 400. This radio transmission can, for example, comprise in-ear monitoring data. The audio data 331, 341 can be composed of the audio data 321, 311 from the two microphones 310, 320 and optionally further audio data. This data can be transmitted as a unicast or multicast from the base station 400. The bodypack or beltpack 350 (receiving unit) can communicate with the base unit 400 in the form of a bidirectional radio transmission. The microphone data that the bodypack or beltpack has received via the microphone input is transmitted to the base station 400 as unicast or multicast, for example. In-ear monitoring data is transmitted from the base station 400 as unicast or multicast.

The audio data of the respective audio data transmitters (microphones 310, 320) can be transmitted using a TDMA method. The TDMA method ensures multiple access to a wireless audio transmission through a temporal sequence of several subscribers. For transmission with low latency, for example, a deterministic and equidistant grid of time slots per audio stream can be used. The minimum latency of a stream is determined by the largest distance between two consecutive time slots assigned to it.

The wireless multi-channel audio system 100 can have a channel bandwidth of 6 MHz, 8 MHz or 10 MHz. The audio transmission can take place in frequency ranges 470-698 MHz (UHF) or 1350-1525 MHz (1G4), in particular in the following frequency bands: TV-UHF (470-608 MHz); TV-UHF China (470-510 MHz and 630-698 MHz); L-Band CEPT (1350-1400 MHz); L-Band USA (1435-1525 MHz).

Subscribers access the transmission channels using Time Division Multiple Access (TDMA). Optionally, the number of subscribers can be up to 128 independent audio streams per broadband channel, for example. The modulation method can be Orthogonal Frequency Division Multiplexing (OFDM) in combination with various subcarrier modulation or coding methods. The audio coding can be accomplished using various methods and sampling rates, as well as in mixed mode. For example, the sampling rates 48 KHz or 96 KHz can be used. Audio coding can be accomplished using the OPUS method, the ADPCM method, the PCM method, or other suitable coding methods (e.g. LC3, SBC). Synchronization of the TDMA grid and the carrier offset estimation (CFO estimation) can be ensured using synchronization patterns. A basic TDMA frame can be divided into ½, ¼, ⅛, or 1/16 access intervals.

The audio transmission can be encrypted. The base station 400 can provide a synchronization signal, manage connected or paired devices and can allocate the corresponding communication resources. The base station 400 can generate audio signals from the audio signals received from the wireless transmitters, which can represent a mixture of the audio signals from the wireless transmitters. These audio signals can then represent an in-ear monitoring audio signal.

The mobile devices 300, 310-350 can register with the base station 400 to enable communication with the base station 400. The mobile devices 310-350 can optionally initiate a transmission of audio data if they have previously detected a base station 400 with which they should communicate.

In this case, it may be necessary for the mobile devices to be “paired” with the base station. Pairing can take place in several steps. Firstly, the operator decides at which frequency the base station will provide the RF channel. Optionally, the base station is set up to identify other transmitters in the permitted frequency band so that the operator can select the frequency for the RF channel so that interference from other transmitters is avoided if possible. The base station transmits a control time slot on the RF channel within a frame. The control time slot contains a unique ID of the base station. After the pairing process on the respective mobile device has been triggered on the mobile devices, for example by pressing a button, the mobile device searches for an RF signal, finds the RF channel of the base station and reads the control time slot. In another control time slot, the mobile device then transmits its own unique ID to the base station and is displayed there as a device that is ready for pairing. The operator of the base station confirms that the mobile device has been found and the base station saves the unique ID of the mobile device. The mobile device receives confirmation of the base station with the next control time slot and in turn saves the unique ID of the base station.

Optionally, the pairing can be completed by the operator of the base station by the user verifying a PIN code of the mobile device. Only after pairing are the mobile devices ready to transmit a signal. Typically, the pairing of the mobile devices with the base station is carried out by a sound engineer before a production so that unpaired devices cannot “eavesdrop” at a later time point. Furthermore, it is not possible for the base station to process signals from unpaired devices.

According to one aspect, the mobile devices 310-350 can also optionally communicate with each other and exchange data.

The audio transmission method can be used for any TDMA audio transmission, in particular a transmission from a base station to a receiver of audio signals from at least two audio channels can take place. An example of such a wireless multi-channel audio system is in-ear monitoring systems, where the base station or a mixer mixes an audio signal based on several audio channels and then transmits this signal wirelessly to in-ear monitoring units.

The base station must therefore have audio data that has several (at least two) audio channels. These audio channels can come from an external source or from wireless microphones in the multi-channel audio system.

Bodypacks can output a stereo signal at the audio output.

Each receiver of the audio samples can check whether the audio samples contained in the frame are intended for them or not. The information as to which of the time slots are intended for a mobile device can be transmitted in advance by the base station to the mobile devices. This can be particularly important in a multi-channel audio system, for example if more than two audio channels are transmitted.

For each of the TDMA resources (i.e. for each stream, frame or time slot) in the audio transmission system, it can be determined by means of which RF modulation the wireless transmission takes place. Examples of RF modulation are Q-PSK or QAM 64. Whereas Q-PSK modulation allows for greater robustness against interference and a higher directional range, QAM 64 modulation enables higher data rates. The total available data rate for a stream is then obtained from the RF modulation used and the number of time slots provided in a frame. In other words, the transmission parameters can be configured for each audio stream.

The audio data transmitted in a stream can be transmitted uncompressed or compressed. The data rate required for uncompressed transmission is obtained from the sample rate (e.g. 48 kHz, 96 KHz). Audio codecs can be used to reduce the data rate. An audio codec can be set by means of parameters such that the audio quality is increased at the expense of the data rate or, conversely, the data rate is reduced at the expense of the audio quality. When using audio codecs, it is important to bear in mind that they have a latency for processing. This latency can be 10 ms, for example.

The respective TDMA resource used also affects the power consumption of the mobile devices and the base station. The more TDMA resources that have to be used for a stream (transmitting/receiving), the higher the power consumption. Using an audio codec can also lead to an increase in power consumption.

For example, with an efficient OPUS codec, good audio quality can be achieved at a data rate of around 80 kbit/s. In wireless transmission, this data rate can be achieved if 8 of, for example, 128 TDMA slots are used with a low modulation (e.g. BPSK). This would also be advantageous in terms of robust modulation at long range. Alternatively, this data rate of 90 kbit/s can be achieved if one time slot of 128 time slots in a frame is used with a high modulation (e.g. QAM 64). Such a stream would have a high modulation at a short range and higher latency. The advantage, however, is that the lower resource requirements for this stream can lead to the TDMA resources not required being used for another channel.

To meet data protection requirements, the communication between the mobile devices and the base station can be encrypted with a symmetric key. The key exchange between the base station and the mobile devices takes place using a public/private key procedure.

FIG. 2 shows a representation of time slots of various wireless transmitters which are received by the wireless receiver. In the TDMA method, the respective audio transmitters are assigned a time slot in a frame. In FIG. 2, eight time slots SL1-SL8 are provided per frame SF as an example. However, this is only an example for illustration purposes. Eight time slots SL1-SL8 can thus be transmitted per frame. The time slots SL1-SL8 are repeated in each frame SF.

In this example, there are three streams S1, S2, S3. Each stream is assigned a wireless audio transmitter. Furthermore, there may be time slots S0 in the frame SF that are not used. In the example in FIG. 2, the first stream S1 requires 2/8 of the resources, the stream S2 4/8 and the stream S3 ⅛ of the resources.

The first stream S1 occupies the time slots SL4 and SL8. The first, third, fifth and seventh time slots SL1, SL3, SL5, SL7 are occupied by the second stream S2. The third stream S3 occupies the time slot SL2. The sixth time slot SL6 is not used.

When transmitting audio data of the respective wireless audio transmitters, it is important that the latency of the respective audio transmission is as low as possible.

FIG. 3 shows a schematic representation of a frame during the transmission of audio data. In particular, FIG. 3 shows a frame SF with eight time slots SL1-SL8. Here, two time slots SL7, SL8 are not required to transmit the audio data. This means that these time slots are free time slots S0. In this example, a first stream S1 uses stream 2/8 of the resources and four further streams S2-S5 each use ⅛ of the resources. Since two time slots S0 are not used, another stream that requires 2/8 of the resources could be accommodated in the frame SF. However, if this stream is inserted at the point where the two unused time slots SL7, SL8 are provided, this can lead to a deterioration in the latency of the new stream.

FIGS. 4A and 4B each show a schematic representation of the audio transmission of audio data from different transmitters in a TDMA method. FIGS. 4A and 4B serve to illustrate the transmission of the respective audio samples in a TDMA time slot and the resulting latency.

In FIG. 4A, a plurality of audio samples AA are shown on the recording side, e.g. on a microphone. These audio samples AA are audio samples of an audio stream, e.g. from a microphone. An analog-digital converter samples an audio signal recorded by a microphone and generates sampled PCM audio samples. The audio samples AA are split up and transmitted in a frame with 8 TDMA time slots SL1-SL8. In FIG. 4A, the audio samples AA are transmitted isochronously (evenly in time) in a fourth time slot SL4 and in an eighth time slot SL8 and output on the playback side as audio samples AW. The latency arises from the time offset between the time when a first audio sample is recorded and when this first audio sample can be played back on the playback side. This results in a latency L1.

In FIG. 4B, a plurality of audio samples AA are also shown on the recording side, i.e., on a microphone. These audio samples are audio samples of an audio stream, e.g., from a microphone. The audio samples AA are divided and transmitted in TDMA time slots SL1-SL8. In FIG. 4B, the audio samples AA are transmitted in a seventh and eighth time slot SL7, SL8, i.e. not isochronously (evenly in time) and are output on the playback side as audio samples AW. This results in a latency L2 which is greater than the latency L1 in an isochronous transmission.

Accordingly, if the audio samples are not transmitted in evenly spaced or distributed TDMA time slots, this can lead to an increase in latency.

FIG. 5 shows a schematic representation of a regrouping of time slots in a frame according to an example. FIG. 5 shows a frame with 8 time slots SL1-SL8. The frame of FIG. 5 above corresponds to the frame of FIG. 3. In the frame, the audio data from 5 audio streams S1 to S5 are to be transmitted. In the initial situation, the first stream S1 occupies the time slots SL1 and SL5. The stream S2 occupies the time slot SL2. The stream S3 occupies the time slot SL3. The stream S4 occupies the time slot SL4. The stream S5 occupies the time slot SL5. The time slots SL7 and SL8 are not occupied.

All the streams that are already active are accordingly distributed isochronously and thus have the best possible audio latency. An additional stream that is to be newly placed has a transmission mode/type that requires two time slots per frame. Since the initially free time slots SL7, SL8 are not distributed isochronously across the frame, the stream that is to be newly placed could not achieve the best possible audio latency.

Therefore, stream S4 is moved from time slot SL3 to SL8. Then, time slots SL3 and SL7 are free, which are at the same time also distributed isochronously. Thus, the new stream can be placed and achieves the best possible latency.

FIG. 6 shows a schematic representation of two audio channels with a different order of the transmission slots of the respective audio data in order to avoid blocking. FIG. 6 describes a special case, namely operation of more than one RF channel in the audio system and, if the mobile devices and in particular the wireless transmitters and wireless receivers are too close to the base station, this can lead to impairment of the reception. Reception can also be impaired if two mobile devices are too close to one another. FIG. 6 describes in particular the situation where in a first and second RF channel R1, R2 a transmitter SS transmits in one time slot and a receiver SE transmits in another time slot. Furthermore, there are time slots SO in which no data is transmitted. A wireless transmitter can transmit data SS via the first and second RF channels R1, R2. The receiver can also transmit data SE via the first and second RF channels R1, R2. This can be data for in-ear monitoring. An unfavourable distribution of time slots is shown on the right-hand side, whilst an improved distribution of time slots is shown on the left-hand side. For example, a frame has eight time slots SL1-SL 8. As can be seen on the right-hand side, the transmitter and receiver transmit simultaneously in the time slots SL1, SL3 and SL6 to SL8. Blocking can occur here. To avoid this, the order of transmission is changed on the left-hand side so that a transmission of the transmitter and the receiver does not take place in any of the time slots. In other words, the transmitter and receiver never transmit at the same time or in the same time slot.

A re-ordering of the time slot occupancy in a TDMA frame can optionally be carried out in three phases, namely a planning phase, a distribution phase and an execution phase. In the planning phase, a user request can be prepared internally whilst the audio transmission system continues to work with the previous configuration without restrictions. In the distribution phase, the changes to be made can be transmitted to all affected mobile devices, for example via the control data. In the execution phase, the changes to be made are carried out without running streams being adversely affected.

FIGS. 7 to 13 show different steps for re-ordering a frame when transmitting audio data.

FIG. 7 shows an initial situation of an audio transmission in a multi-channel audio transmission system, e.g. according to FIG. 1 with four streams of type B and eight streams of type A. The streams of type B require 2/16 of the TDMA resources and the eight streams of type A require 1/16 of the resources. The four streams M1-M4 of type B require 8/16 of the TDMA resources. The eight streams M5-M8 and M9-M12 of type B each require 1/16 of the resources. FIG. 7 shows an example of a frame with 16 TDMA time slots. The streams M1-M4 occupy the time slots SL1-SL4 and the time slots SL9-SL12. The streams M5-M8 each occupy the time slots SL5-SL8 and the streams M9-M12 occupy the time slots SL13-SL16. In the initial situation of FIG. 7, the streams M1-M4 are already arranged isochronously in the frame.

In particular, FIG. 8 shows a situation after a user interaction from the initial situation in FIG. 7. In the situation shown in FIG. 8, the user of the system would like to reconfigure the system and use a higher quality stream of type D, i.e. with 8/16 TDMA time slots per frame. To do this, the first and second streams M1, M2 and the four streams M5, M6, M9 and M10 are deleted. After deleting these streams, eight time slots are free so that the user can insert his desired stream. FIG. 8 shows two ways of placing the new stream M13 in the frame. The first option uses the odd time slots and the second option uses the even time slots. However, it turns out that this leads to collisions with the previously specified streams M3, M4, M7, M8, M11, M12.

With the method according to the invention for redistributing the time slots, a new distribution must be found in which all the streams can be accommodated in the frame and in which an isochronous distribution is carried out for each stream in order to obtain a reduced latency.

Due to the change initiated by the user the planning phase is initiated, during which the system determines an optimal redistribution in the background. The redistribution process starts with the search for an offset that is not used by a larger or equally large link. Furthermore, it can also be checked whether there are any collisions with other streams on the time slots.

The offset of a stream corresponds to the index of the stream in the time slots and specifically when the stream is transmitted for the first time in the frame. Stream M4 therefore has an index of 4 since it was transmitted for the first time in the fourth time slot SL4. Stream M11 has an index of 15 since stream M11 was transmitted for the first time in the time slot SL15. The index therefore represents the distance from the start of the time slot to the first transmission of the stream.

In the first step of the redistribution or re-allocation process, the offsets of the streams are examined to determine those offsets that are not occupied by a larger or equal occupancy of TDMA resources. If the offset is 1, this applies to the streams in the time slots SL1, SL3, SL5, SL7, SL9, SL11, SL13 and SL15. It can also be checked whether there are any collisions with other streams on the time slots.

In the next step, a placement of the new stream in the frame is planned and all those streams in the time slots that are now occupied by the new stream and would thus displace the previous streams are recorded. For the possibility of the new stream M13 in FIG. 8, these are the streams M3, M7 and M11. For the possibility M2, these would be the streams M4, M8 and M12.

In the next step of the re-allocation or redistribution process, the streams that have been displaced by the new stream are sorted according to their TDMA resource requirements. In this new list, stream M3 is at the top since this requires 2/16 TDMA resources, whilst streams M7 and M11 each only require 1/16 TDMA resources. Thus, stream M3 is larger and requires more TDMA resources.

FIG. 9 shows a frame in which the new stream M13 has been placed isochronously and the streams M3, M7 and M11 that were displaced thereby have been removed. Since the new stream M13 requires 8/16 TDMA resources, it must be inserted either with offset 1 (i.e., in time slot SL1) or offset 2 (i.e., in time slot 2). In FIG. 9, the new stream M13 has been inserted with offset 1, i.e. the new stream M13 transmits for the first time in the first time slot SL1.

Subsequently, in the planning phase, the displaced streams M3, M7 and M11 must be shifted so that they can be accommodated isochronously in the frame.

FIG. 10 shows how a search for a new index for stream M3 is conducted. FIG. 10 shows eight different options for an offset for stream M3. In option 1, namely offset 1, this is not possible since the new stream M13 with a higher TDMA resource requirement is already located there. At offset 2, there are no colliding streams. At the other offsets 3, 5 and 7, placement of stream M3 is not possible since the stream M13 with a higher TDMA resource requirement is already located there. At offset 4, there is a colliding stream, namely stream M4. At offset 6, there are no colliding streams. At offset 8, there are two colliding streams, namely M8 and M12.

FIG. 11 shows a frame in which the stream M3 has been placed. An offset of 2 is chosen for the stream M3, so that the stream M3 is provided in the second time slot SL2 and in the tenth time slot SL10.

After a place for stream M3 has been found, streams M7 and M11 still need to be placed.

FIG. 12 now also shows the placement of streams M7 and M11. Stream M7 is placed in time slot SL6 and stream M11 is placed in time slot SL14. This means that a re-allocation or redistribution of the streams in the time slots of the frame has been found. Thus, the planning phase can be ended. In the new arrangement of the respective streams in the time slots of the frame, all the streams are accommodated and all the streams are distributed isochronously. Since streams M7 and M11 require the same TDMA resources, the order in which they are shifted is not relevant. Stream M7 is placed with an offset of 6, i.e. stream M7 is placed in the sixth time slot SL6, since this is not occupied by any other stream. Stream M11 is placed with an offset of 14, since time slot SL14 is not occupied by any other stream. Thus, the planning phase is ended. It should be noted that stream M3 must be shifted before the new stream M13 is placed.

The distribution phase is described in detail hereinafter. In the distribution phase, care must be taken to ensure that the displacement and addition of the stream takes place synchronously and that all the mobile devices involved are aware of the planned redistribution. This information can be transmitted from the base station to the mobile devices by means of the control data. Optionally, the base station can receive a confirmation from the mobile devices before the redistribution is initiated. If no confirmation has been received from all mobile devices involved, the base station disconnects the connection to the devices from which no confirmation has been received. These must then reconnect.

For the redistribution and synchronization, a time synchronization of all the subscribers can be used. A frame counter can be used as a common time base, for example, which makes it possible to assign a time stamp to each of the transmitted and received data packets.

For example, a current frame time of 123 can be assumed. With a frame time of 123+1000 (time out offset)+0 (shift overlap), stream M11 is shifted from offset 15 to offset 14. With a frame time of 123+1000 time out offset+2 (shift overlap), stream M7 is shifted from offset 7 to offset 6. With a frame time of 123+1000 time out offset+4 (shift overlap), stream M3 is shifted from offset 3 to 4. With a frame time of 123+1000 (time out offset)+6 (shift overlap), stream M13 is placed at offset 1.

The shift overlap can be a fixed time constant, e.g., 2. This time constant specifies here much time must be waited between the individual steps of the previously created plan. The background is that the streams need a certain amount of time to change the offset: M13 is placed at 123+1000 (one-time time out offset)+2 (shift overlap of M11)+2 (shift overlap of M7)+2 (shift overlap of M3). The times for the individual processes are always increased by an additional shift overlap from the previous one.

This shift plan can be transmitted to the mobile devices. A time out offset of 1000 is used to ensure that the wirelessly connected mobile devices have received the configuration safely or stop communicating and try to reconnect to the base station.

If the M11 stream has difficulty receiving the transmitted information from the base station, the base station can detect that the M11 stream has not sent an acknowledgement of receipt of the message. Therefore, the base station will re-deliver the message for a certain period of time. If the base station then receives a confirmation for a retransmission, it is ensured that the M11 stream has received the information and can make the changes accordingly.

If no acknowledgement has been received from the respective stream after a period of time has elapsed, for example half of the time-out offset, e.g. after 500 frames despite retransmission, then the base station can assume that the connection to the stream M11 has been lost and stops communicating with stream M11. After a further time interval has elapsed, stream M11 can determine that communication with the base station has been lost and stops transmitting. Stream M11 can then try to re-establish the connection. As soon as the connection is established, the base station transmits the valid information for transmitting or receiving the stream.

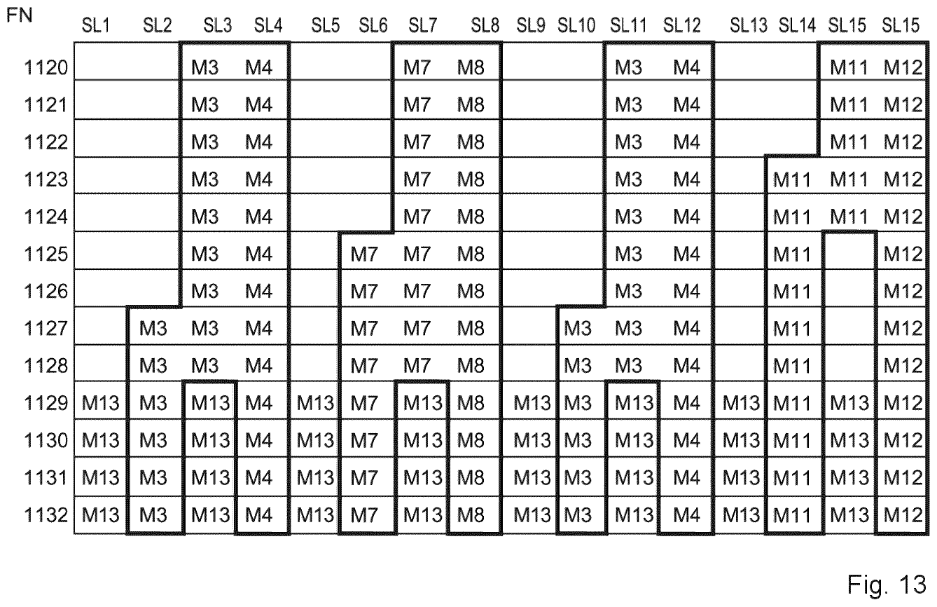

FIG. 13 shows the various procedural steps for realizing the re-allocation or redistribution of the various streams in the frame. In the execution phase, all the subscribers should begin synchronously with the execution of the distribution plan. Within a shift overlap (for example two frames), the corresponding streams may be transmitted on both offsets simultaneously. For a frame number 1120, the occupancy of the time slots in the frame is as shown in FIG. 8, i.e. some previous streams have been removed from the time slots and a new stream M13 is to be inserted. For frame numbers 1123-1124, stream M11 is shifted from time slot 15 to time slot 14. This also takes place in frame number 1124. In frame number 1125, a transmission of stream M11 in time slot 15 is prevented and stream M7 is transmitted in both time slot S6 and time slot S7. The same applies to frame number 1126. In frame number 1127, the third stream M3 is transmitted in the second, third, tenth and eleventh time slots. In frame number 1127, both stream M11 and stream M7 have finished their shifting. In time slot 1129, stream M13 is placed and the shifting of stream M3 is finished. The redistribution is then finished.

In the example shown, the first three planned shifts, namely the shift of streams M11, M7 and M3, can be carried out simultaneously since the newly planned time slots (offsets) are free. If this has been detected in the planning phase, this can be taken into account in the execution phase so that the planning phase can be carried out more quickly. However, in larger and more complex scenarios with larger frames, a target offset can only be freed up by a previous shift operation. During the shift process, the affected streams have twice the data rate available for a short time. Within this time, the data processing on the transmitter and receiver side must switch processing to the new grid. The behaviour can vary depending on the codec used. If a codec enables processing in very small blocks or sample-by-sample processing, a TDMA resource can only be partially filled in the transition area in order to shift the grid.

FIGS. 14A and 14B show a schematic representation of a transmission of audio samples in TDMA time slots. FIG. 14 shows the behaviour in the overlap area of sample-based processing. In particular, FIG. 14A shows sample-based processing and FIG. 14B shows block-based processing. For codecs with larger blocks, it is more efficient to work in parallel on both grids during the overlap phase, as shown in FIG. 14B. On the receiver side, all slots can be decoded and audio data in the overlap area can be cross faded onto the data.

FIG. 15 shows a schematic representation of a binary tree for determining a re-allocation or redistribution in a frame. A re-allocation or redistribution method for time slots in a frame is described in detail below:

If an additional audio stream is to be placed in a frame in which several audio streams are already present, it can occur that the available free time slots are fragmented and are not suitable for accommodating the new audio stream. In such cases, the time slots in the frame must be re-allocated or redistributed. First, those streams that have the highest TDMA resource requirements are considered. Then, those streams with a lower TDMA resource requirement are considered in the distribution.

In a first step, the time slots in the frame are analyzed to determine those time slots that are not occupied by a stream with a high or equal TDMA resource requirement. In particular, a so-called offset can be determined here. This offset corresponds to the number of the time slot that is free or is not occupied by a stream with a higher or equally high TDMA resource requirement. These offsets then represent the time slots where a new stream can be placed or re-embedded.

The offset describes the first time slot in a TDMA frame that a stream can access. This is usually followed by others at fixed intervals (depending on the stream type). A stream type requires 2/16 of the resources and is placed at offset 2. This means that it can use time slots “SL2” and “SL10”. A stream type with 8/16 of the resources is placed at offset 1 and can use SL1, SL3, SL5, etc. When checking whether a stream can be placed, the condition “time slot which is free or not by a stream with a higher or equally high TDMA resource requirement” must be checked for several time slots if necessary.

In a second step, the new stream or stream to be relocated is then placed at the offset position and all other streams in the frame that are displaced by the new or newly placed stream are included in a list. Preferably, those offsets can be used that have the least displacement of previously existing streams in the time slots of the frame.

In the third step, the list is sorted according to the TDMA resource requirements. In the fourth step, the next stream on the list is used and an offset (i.e. a time slot in the frame) is sought that is not occupied by a stream with higher or equally high TDMA resource requirements. The fourth step S4 corresponds to step 1. The stream with the determined offset is then placed and this stream can then be deleted from the list. The streams displaced in this way can be included in the list. If the list has not yet been processed, the process is then repeated from the third step. By skillfully selecting the placement of a stream in one of the available offsets, the number of steps required for the re-allocation or redistribution can be reduced.

According to one aspect, the re-allocation or redistribution process can be based on a binary tree. The binary tree can be used to partition a time slot table or time slot vector. This is particularly shown in FIG. 15. In FIG. 15, an example of a frame with eight slots is shown. These eight slots are divided into two slots of four, which are each in turn divided into two slots of two. The slots of two are then in turn divided into two individual time slots. This achieves a binary tree with four levels. The time slot offsets for each level in the binary tree can be achieved by bitwise inversion of their index. For example, at level 3, a node with linear index=0b100=4 may be represented by time slot offset 0b001=1.

In the procedure for re-allocation or redistribution, care can be taken to ensure that if a node is assigned to a stream, then all of its parent nodes must be. In other words, when a node is re-allocated or relocated, none of the time slots of the new placement may be occupied by a stream with higher resource requirements. In the tree representation, this criterion can be checked by testing whether the parent nodes are not occupied by streams, i.e., are free.

The procedure for re-allocating or redistributing the time slots with the least possible additional fragmentation is accomplished hereinafter. In the event that various free nodes can be used for a stream, the node that causes the least additional fragmentation should be used when selecting the corresponding node. This can be accomplished, for example, by placing the stream to be placed in the subtree where the additional stream just fits, i.e. in the subtree that has the fewest number of free time slots.

This can be accomplished as follows: In step 1, a list with possible nodes is generated. In step 2, the nodes in an upper level are considered for each possible candidate. In step 3, the number of occupied nodes in the subtree is counted. In step S4, the node with the highest number of nodes occupied in a parent subtree is selected. If there are several with the same number of occupied nodes, then processing can take place further in step 2.

The following describes a re-allocation or redistribution method that performs blocking between a wireless transmitter and a wireless receiver when they are located close to the base station. This is achieved by placing the streams from the wireless transmitters (such as wireless microphones) starting from a linear index of 0. Wireless receivers (such as in-ear monitoring systems) are placed from the opposite direction, namely for a linear index (2^{level}−1).

According to one aspect, the re-allocation or redistribution of the time slots in the frame is achieved, for example, as follows:

In a first step, possible time slot offsets are checked if no parent part is occupied by a stream. In the second step, a stream can be placed directly if the offsets of the children are free. In the third step, a stream can be placed directly if several offsets are unoccupied and their children are also free. In the fourth step, defragmentation takes place if there is no node without occupied children. In step 5, the node with the fewest number of occupied children is used. The stream can be placed here and the displaced streams in the child nodes can be included in the list of streams to be newly placed. In step 6, the list is sorted and in step 7, processing can return to the first step until the list is processed.

The changes to the time slot allocation determined here can optionally be implemented in the reverse order. The changes determined in this way must be carried out in the reverse order. Otherwise, the sound on the displaced streams will be interrupted.

Optionally, to reduce the number of mobile devices that need to perform the changes, the fourth step can be linked by weighting each child node with the number of mobile devices associated with it.

According to one aspect, it can be useful to configure the re-allocation or redistribution in such a way that it is not the number of streams moved is minimized, but the number of mobile devices that have to participate in the defragmentation can be reduced.

Some non-optimal cases of stream relocation are described hereinafter as examples. The node 2 slots offset 1 can be occupied and 19 wireless receivers (in-ear monitoring) can be connected thereto. The node 1 offset 0 can be occupied and 10 wireless receivers can be connected thereto. The node 1 slot offset 2 can be occupied and 10 wireless receivers can be connected thereto. If a stream with four slots is to be inserted into the frame, then it can occur that this new stream is inserted with offset 1, since this node represents the subtree with the smallest number of mobile devices connected thereto. This would lead to a displacement of the stream located there, which in turn can lead to a further displacement of other streams. This can have the result that the streams from 29 different mobile devices have to be redistributed. However, if the new four time-slot stream is placed in slot offset 0, then only 20 mobile devices have to be shifted.

According to one aspect, optimal occupancy can be achieved by performing a complete search with all possible options.

Optionally, a proactive defragmentation or a proactive re-allocation and redistribution process can be provided. This proactive redistribution can be triggered by various triggers. These triggers can represent a time interval in which nothing has happened, a trigger can represent a deletion of a stream and/or a trigger can represent the addition of a stream.

Optionally, in proactive redistribution, the redistribution can be performed in such a way that the largest possible space or the largest possible time is freed up. When deleting a stream or adding a stream, it can be useful to wait to see if another stream is deleted or added before performing proactive defragmentation.

### REFERENCE LIST

100 Wireless multi-channel audio system
200 Antenna
201 Control data
202 Cable
300 Mobile devices
310 Handheld microphone (mobile transmitter)
311 First audio data
320 Multi-channel microphone (mobile transmitter)
321 Second audio data
330 First bodypack or beltpack (mobile receiver)
331 Audio data
340 Second bodypack or beltpack (mobile receiver)
341 Audio data
350 Mobile receiver
351 Third audio data
400 Base station
500 Control console
600 Mixer

1. Method for controlling a wireless multi-channel audio system (100), wherein the system (100) has at least two mobile devices (300), each for transmitting and/or receiving audio data in the form of at least one audio stream, and at least one base station (400), wherein the mobile devices (300) and the base station (400) exchange audio data wirelessly in a Time Division Multiplex Access TDMA method, wherein this wireless transmission takes place on the basis of repeating frames (SF), wherein each frame (SF) has a number (A) of time slots (SL), wherein each mobile device (300) transmits or receives audio data of an audio stream in at least one time slot (SL) at least once per frame (SF), wherein each audio stream transmitted in the frame (SF) occupies a proportion (T) of the time slots (SL) of the frame (SF), wherein the base station (400) transmits control data (201) to the mobile devices (300) for controlling the wireless transmission, with the steps:
in response to a user input to add additional audio data from at least one additional audio stream:
searching for at least one time slot (SL) in the frame (SF) which is not occupied by an audio stream with a larger or equal proportion (T) of the time slots (SL),
placing a new audio stream in the found at least one time slot (SL),
recording all existing audio streams that have already been displaced as a result,
searching for at least one further time slot (SL) in the frame (SF) for a next or a displaced audio stream, which is not occupied by an audio stream with a larger or equal proportion (T) of the time slots (SL),
placing a new or displaced audio stream in the additional time slot (SL) which has been found, and
repeating the steps of searching and placing until all the audio streams are accommodated in the time slots,
wherein each audio stream is substantially isochronously distributed in the time slots of the frames.

2. Method for controlling a wireless multi-channel audio system (100) according to claim 1, wherein
that time slot which has been found is used to place a next or displaced audio stream, in which placing the audio stream displaces the fewest previously placed audio streams from the time slots.

3. Method for controlling a wireless multi-channel audio system (100) according to claim 1, wherein
the wireless transmission takes place in frequency bands 470 MHz-608 MHz; 470 MHz-510 MHz, 610 MHz-698 MHz, 1350-400 MHz; or 1435-1525 MHz.

4. Method for controlling a wireless multi-channel audio system (100) according to one of claims 1, wherein
the mobile devices (300) represent wireless transmitters and/or wireless receivers,
wherein the wireless transmitters are configured as wireless microphones and the wireless receivers are configured as in-ear monitoring units.

5. Method for controlling a wireless multi-channel audio system (100) according to claim 1, wherein
the base station (400) transmits information to the mobile devices by means of the control data (201) for the re-allocation or redistribution of the occupancy of the time slots in the frame,
wherein the mobile devices (300) then transmit or receive based on the control data in the time slots assigned to them.

6. Method for controlling a wireless multi-channel audio system (100) according to claim 1, wherein
the control data (201) comprises information for each mobile device (300) at the time and at the new starting time slot.

7. Wireless multi-channel audio system (100) according to ETSI EN 300422, comprising at least two mobile devices (300) each for transmitting and/or receiving audio data in the form of at least one audio stream and
at least one base station (400),
wherein the mobile devices (300) and the base station (400) are configured to exchange audio data wirelessly in a TDMA method,
wherein the wireless transmission is based on repeating frames,
wherein each frame has a number (A) of time slots,
wherein each mobile device transmits or receives audio data of an audio stream in at least one time slot at least once per frame,
wherein each audio stream transmitted in the frame occupies a proportion (T) of the time slots of the frame,
wherein the base station (400) is configured to transmit control data to the mobile devices for controlling the wireless transmission,
wherein the base station (400) is configured to:
in response to a user request to add additional audio data of at least one additional audio stream:
to search for at least one time slot (SL) in the frame (SF) which is not occupied by an audio stream with a larger or equal proportion (T) of the time slots (SL),
to place a new audio stream in the at least one time slot which has been found,
to record at least one already existing audio stream that has been displaced thereby,
to search for at least one more time slot in the frame for a next or displaced audio stream, which is not occupied by an audio stream with a larger or equal proportion (T) of the time slots,
to place a new or displaced audio stream in the additional time slot which has been found, and
to repeat the steps of searching and placing until all the audio streams are recorded in the time slots,
wherein each audio stream is substantially isochronously distributed in the time slots of the frames.
